(19) United States
(12) Patent Application Publication
(10) Pub. No.: US 2025/0058759 A1
(43) Pub. Date: Feb. 20, 2025

(54) ACTUATOR ASSEMBLY

(71) Applicant: ZF Active Safety GmbH, Koblenz (DE)

(72) Inventors: Lukas Madzgalla, Lahnstein (DE); Jason Sauerberg, Neuhaeusel (DE); Florian Roessinger, Neuwied (DE); Marco Becker, Oberduerenbach (DE)

(21) Appl. No.: 18/808,154

(22) Filed: Aug. 19, 2024

(30) Foreign Application Priority Data
Aug. 18, 2023 (DE) 102023122193.0

(51) Int. Cl. B60T 13/74; F16D 55/00; F16D 55/226; F16D 65/00; F16D 65/18; F16D 121/24; F16D 125/40; F16D 125/50

(52) U.S. Cl. CPC B60T 13/746; F16D 55/226; F16D 65/0068; F16D 65/18; F16D 2055/0016; F16D 2121/24; F16D 2125/40; F16D 2125/50

(57) ABSTRACT

An actuator sub-assembly for an electromotive vehicle brake is set out, having a brake calliper, in which an intermediate space for receiving a brake rotor is provided. A spindle drive is also provided, which has a sliding actuation member for applying a brake pad to the brake rotor. The sub-assembly also includes an electro-motively driven spindle for axially moving the sliding actuation member, an electric motor which is drivingly coupled to the spindle by a gear mechanism unit, and a housing, in which the gear mechanism unit is accommodated. A plate-like frame portion, which has a receiving space for at least one gear stage of the gear mechanism unit is also arranged in the housing. Starting from the frame portion, at least one web-like continuation extends in the direction towards the brake calliper and is secured to the brake calliper.

### CROSS-REFERENCE TO RELATED APPLICATIONS

This application claims priority to German Application No. 102023122193.0, filed on Aug. 18, 2023, the disclosure of which is incorporated herein by reference in its entirety.

### TECHNICAL FIELD

The disclosure relates to an actuator sub-assembly for a vehicle brake.

### BACKGROUND

Actuator sub-assemblies are used in vehicle brakes to apply a brake pad to a brake rotor. To this end, the actuator sub-assembly generally has a spindle drive which has a sliding actuation member and an electro-motively driven spindle for axially moving the sliding actuation member, wherein an axial positioning force for applying the brake pad to the brake rotor is transmitted from the spindle nut to the brake pad.

The spindle drive is generally accommodated for the most part in a brake calliper which is in the form of a cast component.

The spindle drive is coupled by a gear mechanism unit to an electric motor in order to drive the spindle drive, wherein the gear mechanism unit is generally accommodated in a plastics material housing which is secured to the brake calliper. The gear mechanism unit itself is supported on a frame portion, which is in torque-transmitting engagement with the brake calliper and which is supported axially on the housing.

The torque which occurs during the movement of the sliding actuation member is consequently transmitted directly to the brake calliper, whilst the axial forces are transmitted via the housing to the brake calliper. The housing is thereby exposed to high loads.

It would be conceivable to also produce the housing for the gear mechanism as a cast component. However, this would have an unfavourable effect on the production costs and the weight of the actuator sub-assembly.

What is therefore needed is to provide an actuator sub-assembly which is improved with respect to the capacity for resistance to the loads which occur during operation.

### SUMMARY

An actuator sub-assembly is disclosed, for example for an electromotive vehicle brake, having a brake calliper, in which an intermediate space for receiving a brake rotor is provided, a spindle drive which has a sliding actuation member for applying a brake pad to the brake rotor and an electro-motively driven spindle for axially moving the sliding actuation member, an electric motor which is drivingly coupled to the spindle by a gear mechanism unit, a housing, in which the gear mechanism unit is accommodated and a plate-like frame portion which has a receiving space for at least one gear stage of the gear mechanism unit and which is also arranged in the housing. Starting from the frame portion, at least one web-like continuation extends in the direction towards the brake calliper and is secured to the brake calliper.

The actuator sub-assembly according to the disclosure has the advantage that axial forces are introduced from the frame portion via the web-like continuation into the brake calliper without the housing in which the gear mechanism unit is accommodated being excessively loaded. Specifically, during operation of the actuator sub-assembly, a torque and axial forces are primarily transmitted to the brake calliper. It is thereby possible to produce the housing from plastics material, whereby the production can be carried out in a cost-effective manner.

The web-like continuation consequently performs the function of a force transmission element which transmits forces between the frame portion and the brake calliper.

The web-like continuation may be formed integrally with the frame portion. In this manner, the handling and the assembly are particularly simple. A multi-component production is, however, also conceivable.

The at least one web-like continuation may extend at least partially between the housing and the brake calliper. The web-like continuation is thereby covered by the housing. For example, the housing can thereby be produced free from additional apertures, whereby the penetration of dirt and moisture into the actuator sub-assembly is avoided.

According to one exemplary arrangement, the at least one web-like continuation is radially and axially fixed to the brake calliper by a securing arrangement which projects in a radial direction through the housing or through the brake calliper. This is advantageous with regard to the assembly since the housing and the brake calliper are easily accessible from the radially outer side. If the securing arrangement extends through the housing, the additional advantage is achieved that the housing is also secured to the brake calliper at the same time as the frame portion.

In one exemplary arrangement, the securing arrangement is, for example, a screw.

There may be provided in the brake calliper a recess, in which the sliding actuation member is guided in an axially displaceable manner, wherein the at least one web-like continuation extends into the recess. This contributes to a stable support of the frame portion on the brake calliper. For example, not only is a torque transmitted via the at least one securing means to the brake calliper, but also the web-like continuation can additionally be supported on the brake calliper by the side edges thereof.

According to one exemplary arrangement, there is arranged on a circumferential face of the sliding actuation member a torsion prevention element which in the event of an axial displacement of the sliding actuation member slides along an inner side of the web-like continuation and is guided on the web-like continuation in a torsion-resistant manner. The web-like continuation consequently performs not only the function of a force transmission element, but instead additionally also that of guiding a torsion prevention member. It is thereby possible to dispense with a separate guide for torsion prevention, whereby the construction of the actuator sub-assembly is less complex.

According to one exemplary arrangement, the frame portion may be supported on the brake calliper in a torsion-resistant manner by a torsion prevention geometry which is arranged on an inner wall, which is directed towards the receiving space, of the frame portion. As a result of such a torsion prevention geometry, a torque transmission between the frame portion and the brake calliper is additionally improved. In addition, the transverse forces acting on the web-like continuation are reduced so that the web-like continuation can be produced to be narrower than when a torsion prevention geometry is not present.

The torsion prevention geometry is, for example, a wedge shaft geometry.

Alternatively or additionally, a planar abutment face, in particular a wedge face, may be provided on the brake calliper, and there may be provided on the web-like continuation a corresponding face which bears on the abutment face. The abutment face may also be used for torsion prevention of the frame portion on the brake calliper so that via the abutment face a torque is also transmitted from the frame portion to the brake calliper.

The frame portion may have a securing interface for the electric motor. By the frame portion being used not only to accommodate the gear mechanism unit, but also to secure the electric motor, a particularly compact construction type of the actuator sub-assembly is achieved.

The gear mechanism unit comprises, for example, a planetary gear mechanism. This also contributes to a compact construction type of the actuator sub-assembly.

The force transmission element may be produced from a material which has a higher strength than the material from which the housing is produced. The force transmission element can thereby transmit sufficiently high forces and a material failure is prevented.

For example, the force transmission element is produced from a metal material.

The housing is, for example, produced from a plastics material.

### BRIEF DESCRIPTION OF THE DRAWINGS

Other advantages and features of the disclosure will be appreciated from the following description and from the appended drawings to which reference is made. In the drawings:

FIG. 1 shows an exemplary arrangement of an actuator sub-assembly according to the disclosure,

FIG. 2 shows a frame portion of the actuator sub-assembly from FIG. 1,

FIG. 3 shows a partially sectioned illustration of a brake calliper of the actuator sub-assembly from FIG. 1,

FIG. 4 shows a cross section through the actuator sub-assembly from FIG. 1 in the region of a web-like continuation,

FIG. 5 shows a portion of an actuator sub-assembly according to another exemplary arrangement according to the disclosure as an exploded illustration,

FIG. 6 shows a frame portion of the actuator sub-assembly from FIG. 5,

FIG. 7 shows a cross section through the partial sub-assembly from FIG. 6,

FIG. 8 shows a torsion prevention geometry between a frame portion and the brake calliper, and

FIG. 9 shows a recess of a brake calliper having a sleeve which is arranged in the recess and a sliding actuation member which is guided in the sleeve.

### DETAILED DESCRIPTION

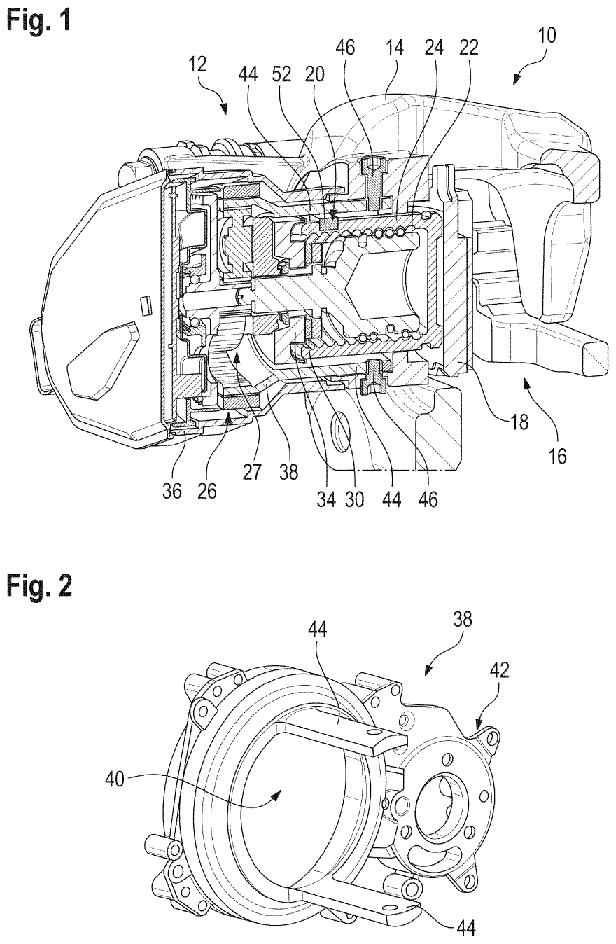

FIG. 1 shows a vehicle brake having an actuator sub-assembly 12. The vehicle brake 10 is an electromechanically actuatable brake.

The actuator sub-assembly 12 comprises a brake calliper 14 in which an intermediate space 16 for a brake rotor is formed. The brake rotor is not illustrated in the Figures for reasons of clarity.

In the intermediate space 16 there is arranged a brake pad 18 which can be applied to the brake rotor.

Furthermore, the actuator sub-assembly 12 comprises a spindle drive 20 which in the exemplary arrangement is a ball screw drive, having a rotatably supported, electromotively driven spindle 22 on which a sliding actuation member 24 is supported. The spindle 22 serves to axially move the sliding actuation member 24.

Specifically, the sliding actuation member can be displaced by means of axial displacement between an extended and a retracted position.

The sliding actuation member 24 represents, for example, a spindle nut.

The actuator sub-assembly 12 further comprises an electric motor which cannot be seen in the Figures. The electric motor is arranged, for example, parallel with the spindle drive 20.

The electric motor is drivingly coupled by a gear mechanism unit 26 and the spindle drive 20 to the sliding actuation member 24 in order to displace the sliding actuation member 24 between the retracted position and the extended position.

The gear mechanism unit 26 comprises in the exemplary arrangement a planetary gear mechanism 27.

An axial displacement of the sliding actuation member 24 is brought about by a rotation of the spindle 22.

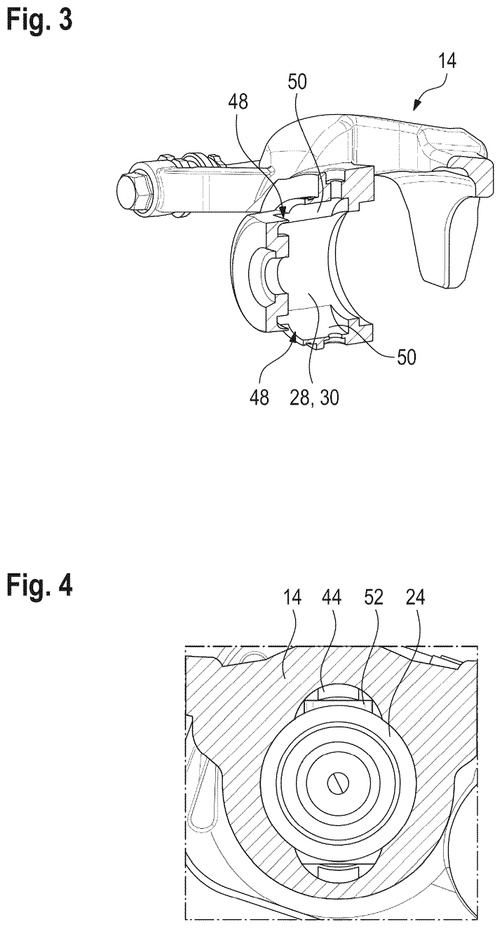

In the brake calliper 14 there is formed a recess 28 on which a running face 30 for the sliding actuation member 24 is formed (see FIG. 3).

The sliding actuation member 24 is axially guided in the running face 30 in a torsion-resistant manner.

The spindle 22 of the spindle drive 20 is supported at a side facing away from the sliding actuation member 24 by an axial bearing 32 on a wall 34 which extends transversely with respect to the movement direction of the sliding actuation member 24.

The gear mechanism unit 26 is accommodated in a housing 36.

In the housing 36 there is additionally arranged a plate-like frame portion 38 which is illustrated in FIG. 2.

The frame portion 38 has a receiving space 40 for at least one gear stage of the gear mechanism unit 26. For example, the planetary gear mechanism 27 is at least partially accommodated in the receiving space 40.

The receiving space 40 is a cylindrical space. In other words, the wall of the receiving space 40 is cylindrical.

The frame portion 38 additionally has a securing interface 42 for the electric motor.

As can be seen in FIGS. 1 and 2, starting from the frame portion 38 two web-like continuations 44 extend in the direction towards the brake calliper 14. In this instance, the web-like continuations 44 extend partially between the brake calliper 14 and the housing 36.

The number of the web-like continuations may vary, for example, the frame portion 38 may have only one or up to four web-like continuations 44.

The web-like continuations 44 are formed integrally with the frame portion 38.

FIG. 1 shows that the web-like continuations 44 are secured to the brake calliper 14.

Specifically, the web-like continuations 44 are radially and axially fixed to the brake calliper 14 by a securing arrangement 46 which projects in a radial direction through the brake calliper 14.

The securing arrangement 46 is a screw in the exemplary arrangement, although other securing arrangements are also contemplated.

As a result of the securing to the brake calliper 14, the web-like continuations 44 in each case form a force transmission element which transmits both axial forces and torques from the frame portion 38 to the brake calliper 14, whereby a loading on the housing 36 is avoided.

In the exemplary arrangement of the actuator sub-assembly 12 as illustrated in FIG. 1, the web-like continuations 44 extend into the recess 28 of the brake calliper 14.

As can be seen in FIG. 3 which shows the brake calliper 14, the brake calliper 14 has to this end an aperture 48 in the direction towards the recess 28.

In addition, recesses 50 in which the web-like continuations 44 extend, are disposed along the running face 30.

As illustrated in FIG. 1 and FIG. 4, which shows a cross section through the actuator sub-assembly 12, the torsion prevention of the sliding actuation member 24 is produced by one of the web-like continuations 44.

For example, a torsion prevention element 52 which bears against the web-like continuation 44 and which is guided thereon in a torsion-resistant manner is arranged on a circumferential face of the sliding actuation member 24. During axial displacement of the sliding actuation member 24, the torsion prevention element 52 slides along the inner side of the web-like continuation 44.

In one exemplary arrangement which is not illustrated in the Figures for reasons of clarity, the recesses 50 may be formed in such a manner that the web-like continuations 44 are received in the recesses 50 in a torsion-resistant manner. In this manner, torques can be even better transmitted from the frame portion 39 to the brake calliper 14.

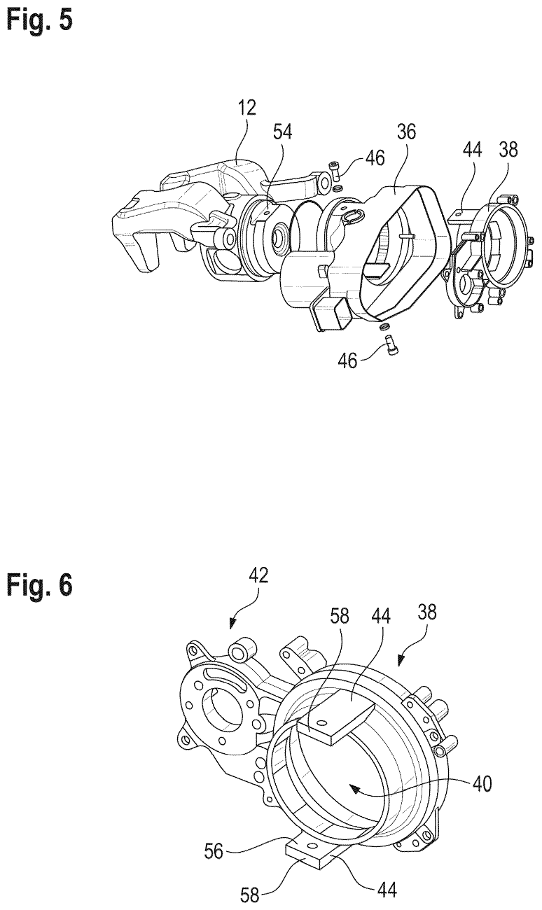

In FIGS. 5 to 7, an alternative exemplary arrangement of an actuator sub-assembly 12 is illustrated, wherein FIG. 5 shows a partial sub-assembly of the actuator sub-assembly 12 which surrounds the brake calliper 14, the housing 36 and the plate-like frame portion 38.

In contrast to the exemplary arrangement described above, the web-like continuations 44 are in this exemplary arrangement are configured to be shorter and do not extend into the recess 28.

As illustrated in FIG. 5, there are formed on the brake calliper 14 planar abutment faces 54 which may be in the form of a wedge face.

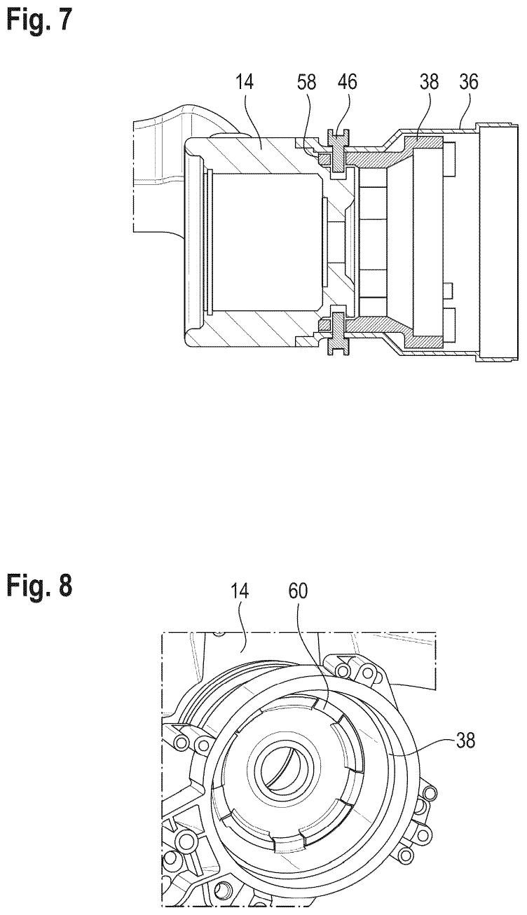

On the web-like continuations 44, there are provided corresponding abutment faces 56 (see FIGS. 6 and 7) which bear on the abutment faces 54.

The continuations 44 extend in this instance between the brake calliper 14 and the housing 36.

With the end faces 58 thereof, the web-like continuations 44 abut the brake calliper 14, as can be seen in FIG. 7.

The radial and axial fixing to the brake calliper 14 is carried out in the exemplary arrangement according to FIGS. 5 to 7 by a securing arrangement 46 which projects in a radial direction through the housing 36 and which is also a screw.

In another exemplary arrangement which is illustrated in FIG. 8, an additional torsion prevention geometry 60 which is arranged on the inner wall of the receiving space 40 can be provided between the frame portion 38 and the brake calliper 14.

The torsion prevention geometry 60 may have a wedge shaft geometry.

An appropriately corresponding geometry is provided on the brake calliper 14 in this instance.

In the exemplary arrangements described above, there is present in the brake calliper 14 in each case the recess 28 in which the sliding actuation member 24 is received and on which the running face 30 for the sliding actuation member 24 is provided.

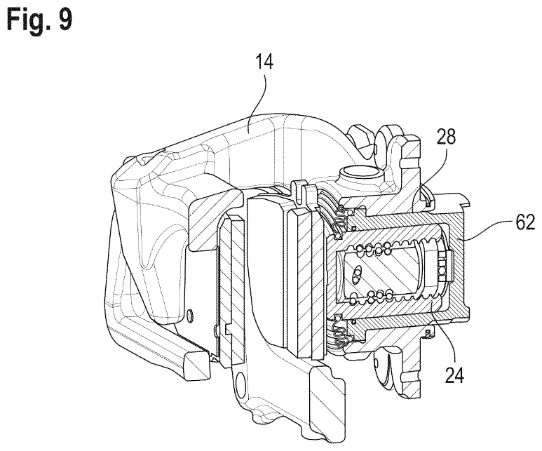

However, it is also conceivable for there to be received in the recess 28 a sleeve 62 on the inner wall of which the running face 30 is formed. This is illustrated with reference to FIG. 9 which shows a brake calliper 14 with a corresponding sleeve 62. Such a sleeve 62 can be used in all the actuator sub-assemblies 12 described above.

If a sleeve 62 is present, a geometry which corresponds to the torsion prevention geometry 60 may also be provided on the sleeve 62.

1. An actuator sub-assembly for an electromotive vehicle brake, comprising:
a brake calliper, in which an intermediate space for receiving a brake rotor is provided,
a spindle drive which has a sliding actuation member for applying a brake pad to the brake rotor and an electromotively driven spindle for axially moving the sliding actuation member,
an electric motor which is drivingly coupled to the spindle by a gear mechanism unit,
a housing, in which the gear mechanism unit is accommodated, and
a plate-like frame portion which has a receiving space for at least one gear stage of the gear mechanism unit and which is also arranged in the housing,
wherein starting from the frame portion, at least one web-like continuation extends in a direction towards the brake calliper and is secured to the brake calliper.

2. An actuator sub-assembly according to claim 1, wherein the at least one web-like continuation extends at least partially between the housing and the brake calliper.

3. An actuator sub-assembly according to claim 1, wherein the at least one web-like continuation is axially and radially fixed to the brake calliper by a securing arrangement which projects in a radial direction through the housing or through the brake calliper.

4. An actuator sub-assembly according to claim 1, wherein there is provided in the brake calliper a recess, in which the sliding actuation member is guided in an axially displaceable manner, wherein the at least one web-like continuation extends into the recess.

5. An actuator sub-assembly according to claim 4, wherein there is arranged on a circumferential face of the sliding actuation member, a torsion prevention element which, in an event of an axial displacement of the sliding actuation member, slides along an inner side of the web-like continuation and is guided on the web-like continuation in a torsion-resistant manner.

6. An actuator sub-assembly according to claim 1, wherein the frame portion is supported on the brake calliper in a torsion-resistant manner by a torsion prevention geometry which is arranged on an inner wall, which is directed towards the receiving space, of the frame portion.

7. An actuator sub-assembly according to claim 1, wherein a planar abutment face, is provided on the brake calliper, and there is provided on the web-like continuation a corresponding face which bears on the abutment face.

8. An actuator sub-assembly according to claim 1, wherein the frame portion has a securing interface for the electric motor.

9. An actuator sub-assembly according to claim 1, wherein the gear mechanism unit comprises a planetary gear mechanism.

10. An actuator sub-assembly according to claim 2, wherein the at least one web-like continuation is axially and radially fixed to the brake calliper by a securing arrangement which projects in a radial direction through the housing or through the brake calliper.

11. An actuator sub-assembly according to claim 10, wherein there is provided in the brake calliper a recess, in which the sliding actuation member is guided in an axially displaceable manner, wherein the at least one web-like continuation extends into the recess.

12. An actuator sub-assembly according to claim 11, wherein there is arranged on a circumferential face of the sliding actuation member, a torsion prevention element which, in an event of an axial displacement of the sliding actuation member, slides along an inner side of the web-like continuation and is guided on the web-like continuation in a torsion-resistant manner.

13. An actuator sub-assembly according to claim 12, wherein the frame portion is supported on the brake calliper in a torsion-resistant manner by a torsion prevention geometry which is arranged on an inner wall, which is directed towards the receiving space, of the frame portion.

14. An actuator sub-assembly according to claim 7, wherein the planar abutment face on the brake calliper is a wedge face.
